(19) United States
(12) Patent Application Publication
(10) Pub. No.: US 2025/0108761 A1
(43) Pub. Date: Apr. 3, 2025

(54) DEVICE FOR ENABLING USER TO ACCESS UPPER PORTION OF VEHICLE

(71) Applicants: JOHN MICHAEL HEIBERGER, Grand Blanc, MI (US); STEPHEN J BRINCK, Center Line, MI (US); KEVIN KONEVAL, Macomb, MI (US); WILLIAM LIANOS, Detroit, MI (US)

(72) Inventors: JOHN MICHAEL HEIBERGER, Grand Blanc, MI (US); STEPHEN J BRINCK, Center Line, MI (US); KEVIN KONEVAL, Macomb, MI (US); WILLIAM LIANOS, Detroit, MI (US)

(21) Appl. No.: 18/373,976

(22) Filed: Sep. 28, 2023

(51) Int. Cl. B60R 3/02

(52) U.S. Cl. CPC B60R 3/02

(57) ABSTRACT

A device for enabling a user to access an upper portion of a vehicle includes a structural member. The structural member includes a proximal end and a distal end. The distal end of the structural member secured within a bracket by means of a returning member. The structural member includes a stepping surface is configured to flexibly move within the bracket by means of the returning member, or a motor-powered unit assembly. The structural member operates between a deployed position and a stowed position thereby enabling the user to access the upper portion of the vehicle. The bracket of the device positioned in one or more vehicle pillars to accommodate the structural member. The stepping surface of the structural member angularly positioned when the structural member operates in the deployed position thereby enabling the user to access the upper portion of the vehicle.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter generally relates to a step device affixed to a vehicle. More particularly, the present disclosure relates to a device for enabling user to access upper portion of vehicle.

### BACKGROUND

Users of vehicles may require access to the vehicle's roof for a variety of reasons, including loading and unloading objects to and from the roof, as well as cleaning the roof. The vehicle's roof is often difficult to reach due to its distance from the ground. Shorter users may also find it challenging to reach the vehicle's roof. Currently, a ladder or a chair is often utilized to load objects onto the vehicle's roof, which is problematic. The inside room of the vehicle will be limited if the ladder or chair is carried inside, and the paint will be damaged if the ladder is affixed to the vehicle. Carrying the ladder or chair inside the vehicle could endanger user safety.

In the light of the aforementioned discussion, there exists a need for a certain system with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a device for enabling user to access upper portion of vehicle.

Another objective of the present disclosure is directed towards enabling a user to load and unload objects onto or from the upper portion of the vehicle efficiently.

Another objective of the present disclosure is directed towards the device that provides high durability.

Another objective of the present disclosure is directed towards the device that provides a better grip to the user's foot when the user accesses the upper portion of the vehicle.

Another objective of the present disclosure is directed towards operating a structural member from a deployed position to a stowed position and vice versa by a returning member.

According to an exemplary aspect of the present disclosure, a device that enables the user to access the upper portion of the vehicle.

According to an exemplary aspect of the present disclosure, a device that includes a structural member, and the structural member includes a proximal end, and a distal end, the distal end of the structural member is secured within a bracket using a returning member.

According to another exemplary aspect of the present disclosure, a stepping surface of the structural member is configured to flexibly move within the bracket using the returning member.

According to another exemplary aspect of the present disclosure, the structural member operates between a deployed position and a stowed position thereby enabling the user to access the upper portion of the vehicle.

According to another exemplary aspect of the present disclosure, a bracket of the device is positioned in one or more vehicle pillars to accommodate the structural member.

According to another exemplary aspect of the present disclosure, the stepping surface of the structural member operates between the deployed position and the stowed position using a motor-powered unit assembly.

According to another exemplary aspect of the present disclosure, a stepping surface of the structural member is angularly positioned when the structural member operates in the deployed position thereby enabling the user to access the upper portion of the vehicle.

According to another exemplary aspect of the present disclosure, a device for enabling a user to access an upper portion of a vehicle includes a structural member. The structural member includes a proximal end and a distal end. The distal end of the structural member is secured within a bracket using a step pin and one or more bushings.

According to another exemplary aspect of the present disclosure, a torsion spring includes a first end and a second end. The first end of the torsion spring is attached to the structural member and the second end of the torsion spring is attached to the bracket.

According to another exemplary aspect of the present disclosure, the torsion spring is configured to rotate the structural member from a stowed position to a deployed position upon applying force on the stepping surface of the structural member by the user.

According to another exemplary aspect of the present disclosure, a compression spring is positioned within the bracket and a cam mechanism is flexibly connected to the bracket using a cam pin. The cam mechanism is configured to engage with the compression spring to control the motion of the structural member from the deployed position to the stowed position when the user removes the force applied from the stepping surface of the structural member.

According to another exemplary aspect of the present disclosure, the torsion spring and the compression spring are configured to enable the structural member to move between the deployed position and the stowed position.

### BRIEF DESCRIPTION OF THE DRAWINGS

FIG. 1 is a diagram depicting a device for enabling a user to access the upper portion of the vehicle, in accordance with one or more exemplary embodiments.

FIG. 2 is a diagram depicting a device fixed to the vehicle pillar to access the upper portion of the vehicle, in accordance with one or more exemplary embodiments.

FIG. 3 is an example diagram depicting a device with a stop member, in accordance with one or more exemplary embodiments.

FIG. 4 is an example diagram depicting an embodiment of deployed position of the structural member, in accordance with one or more exemplary embodiments.

FIG. 5 is an example diagram depicting an embodiment of stowed position of the structural member, in accordance with one or more exemplary embodiments.

FIG. 6 is another example diagram depicting a device for accessing an upper portion of the vehicle, in accordance with one or more exemplary embodiments.

FIG. 7 is another example diagram depicting a device fixed to the vehicle pillar, in accordance with one or more exemplary embodiments.

FIG. 8 is another example diagram depicting an embodiment of deployed position of the device, in accordance with one or more exemplary embodiments.

FIGS. 9A and 9B are other example diagrams depicting a detailed view of the ball and spring mechanism of the device, in accordance with one or more exemplary embodiments.

FIG. 10A is an example diagram depicting a detailed view of power operated device in a stowed position, in accordance with one or more exemplary embodiments.

FIG. 10B is an example diagram depicting a detailed view of power operated device in a deployed position, in accordance with one or more exemplary embodiments.

FIG. 10C is an example diagram depicting a detailed view of the power-operated device, in accordance with one or more exemplary embodiments.

FIG. 11A and FIG. 11B are example diagrams depicting detailed views of a structural member stowed position and deployed position, in accordance with one or more exemplary embodiments.

FIG. 12 is an example diagram depicting a detailed view of a toggle mechanism for operating the device between deployed position and stowed position, in accordance with one or more exemplary embodiments.

FIG. 13 is an example diagram depicting an embodiment of stowed position of the structural member using a toggle mechanism, in accordance with one or more exemplary embodiments.

FIG. 14 is an example diagram depicting an embodiment of transitioning the structural member from the stowed position to the deployed position, in accordance with one or more exemplary embodiments.

FIG. 15 is an example diagram depicting an embodiment of transitioning the structural member from the deployed position to the stowed position using a toggle mechanism, in accordance with one or more exemplary embodiments.

FIG. 16 is a flow diagram depicting a method for accessing an upper portion of the vehicle using the device, in accordance with one or more exemplary embodiments.

### REFERENCE NUMERALS IN THE DRAWINGS

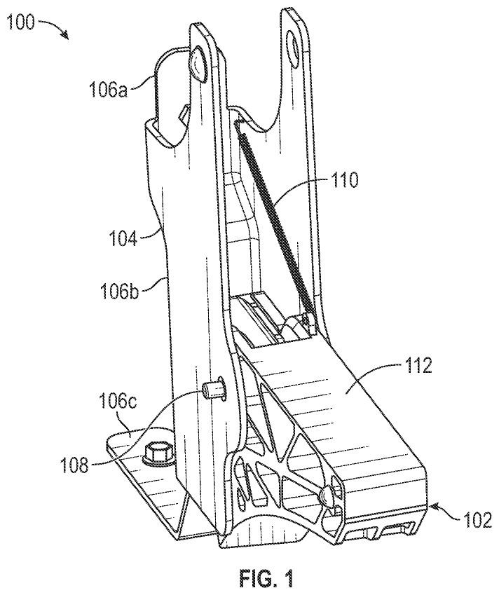

FIG. 1, 100 discloses a device for accessing upper portion of the vehicle
102 Structural member of 100 device
104 Bracket
106a Proximal portion of the Bracket
106b Middle portion of the Bracket
106c Distal portion of the Bracket
108 Pin
110 Returning member
112 Stepping surface of 102 Structural member

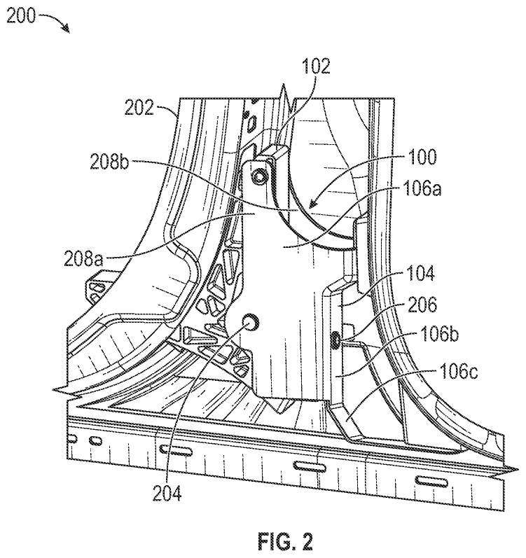

FIG. 2, 200 discloses device is fixed to the vehicle pillar to access the upper portion of the vehicle
202 Vehicle pillars
102 Structural member
104 Bracket
106a Proximal portion of the securing member
106b Middle portion of the securing member
106c Distal portion of the securing member
204 Pin
206 Hole
112 Stepping surface of 102 Structural member

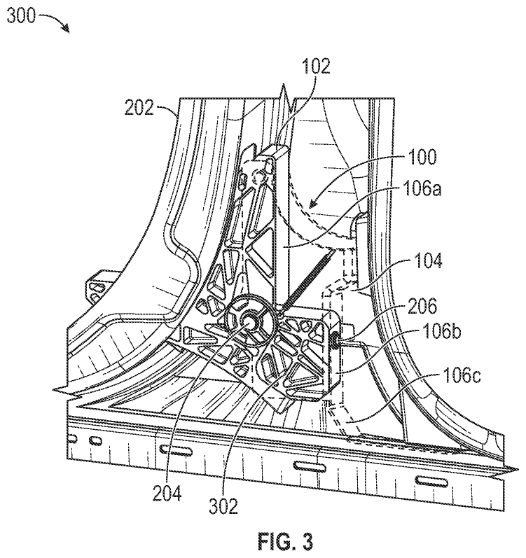

FIG. 3, 300 discloses a stop member of the device 100
202 Vehicle pillars
102 Structural member
104 Securing member
106a Proximal portion of the securing member
106b Middle portion of the securing member
106c Distal portion of the securing member
110 Returning member
204 Pin
206 Hole
302 Stop member

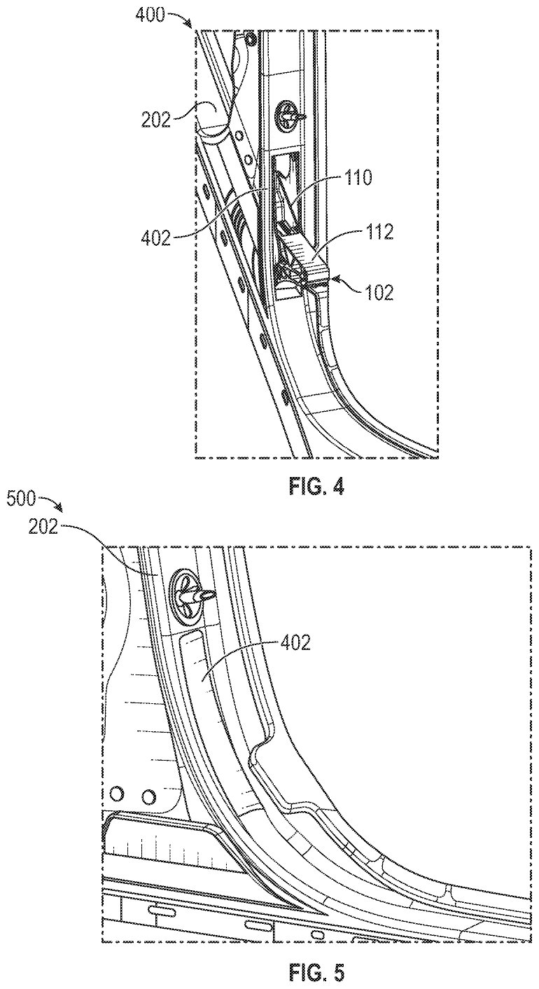

FIG. 4, 400 discloses deployed position of the structural member 102
202 Vehicle pillars
110 Returning member
102 Structural member
112 Stepping surface of 102 Structural member

FIG. 5, 500 discloses stowed position of 102 the structural member
202 Vehicle pillars

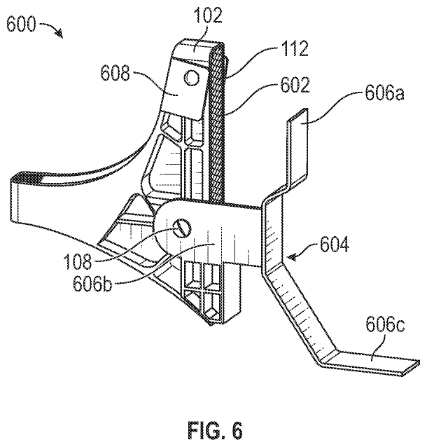

FIG. 6, 600 discloses a device for accessing an upper portion of the vehicle
102 Structural member of 100 device
112 Stepping surface of 102 Structural member
108 Pin
602 Pad
604 Bracket
606a Proximal portion of the bracket 604
606b Middle portion of the bracket 604
606c Distal portion of the bracket 604
608 Ball and spring mechanism

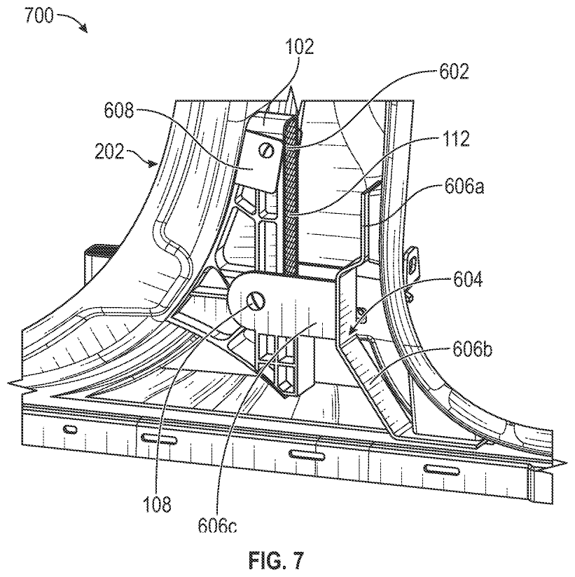

FIG. 7, 700 discloses device is fixed to the vehicle pillar
202 Vehicle pillars
102 Structural member
112 Stepping surface of 102 Structural member
604 Bracket
606a Proximal portion of the bracket 604
606b Middle portion of the bracket 604
606c Distal portion of the bracket 604
608 Ball spring mechanism
108 Pin

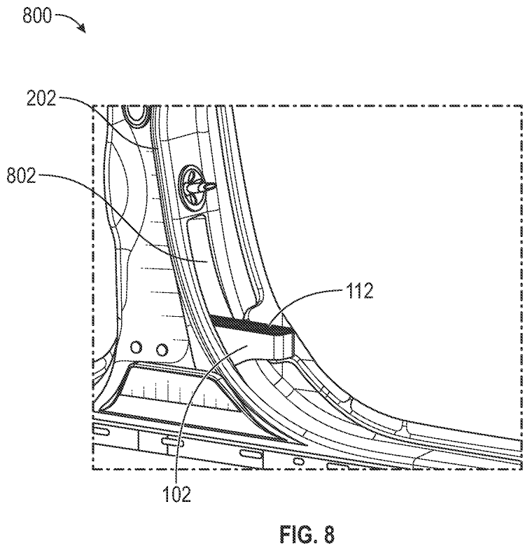

FIG. 8, 800 discloses deployed position of the structural member 102
202 Vehicle pillars
802 Cavity
102 Structural member
112 Stepping surface

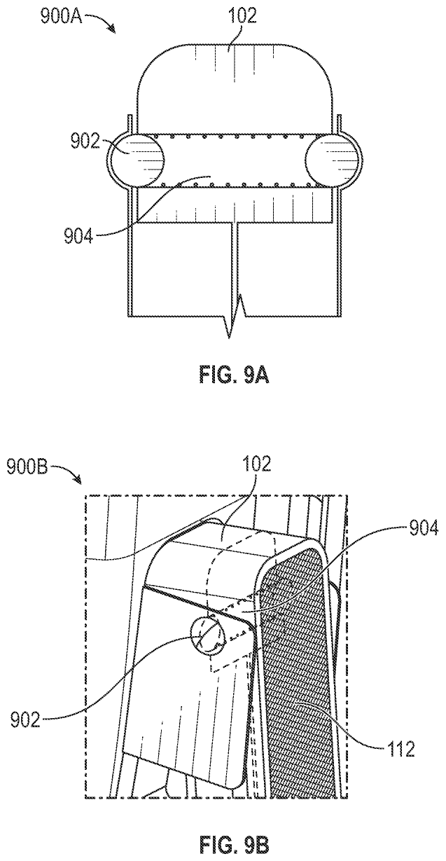

FIGS. 9A and 9B, 900a and 900b disclose a detailed view of the ball and spring mechanism
902 Ball
904 Spring
102 Structural member
112 Stepping surface

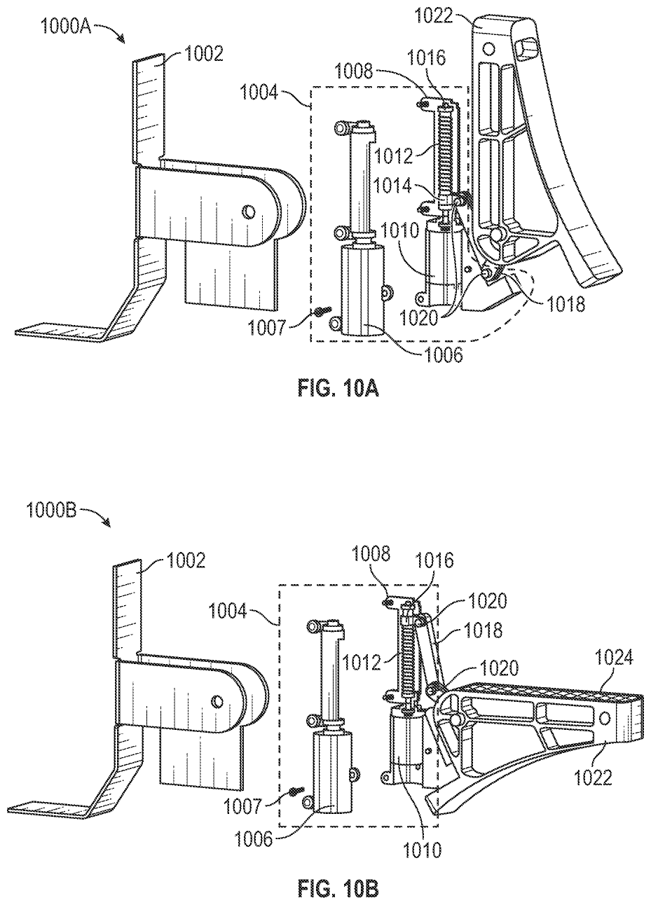

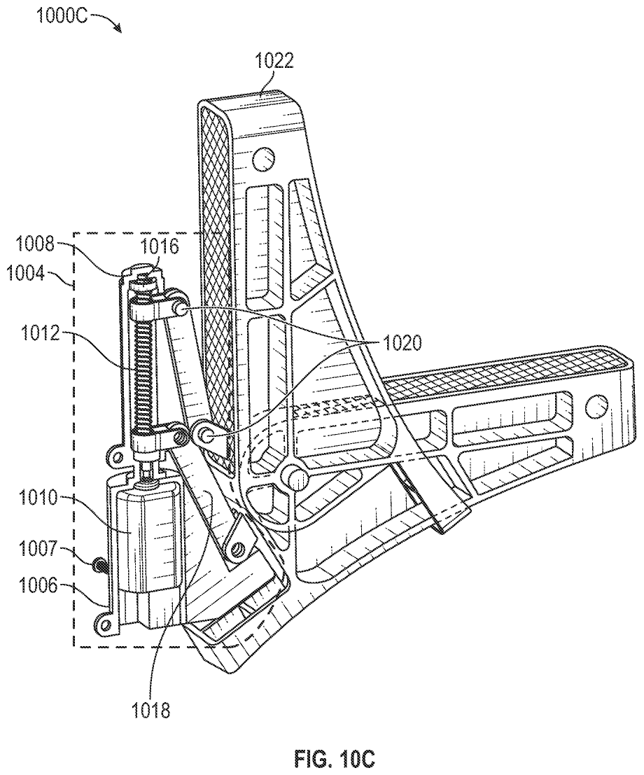

FIG. 10A, FIG. 10B, FIG. 10C are example diagrams are detailed views of a device operated with power
1002 Bracket
1004 Motor powered unit assembly
1006 First housing halve
1007 Attachment screws
1008 Second housing halve
1010 Motor
1012 Leadscrew
1014 Nut
1016 Bearing
1018 Linkage
1020 Pivot pins
1022 Structural member
1024 Stepping surface
1026 Sheet metal

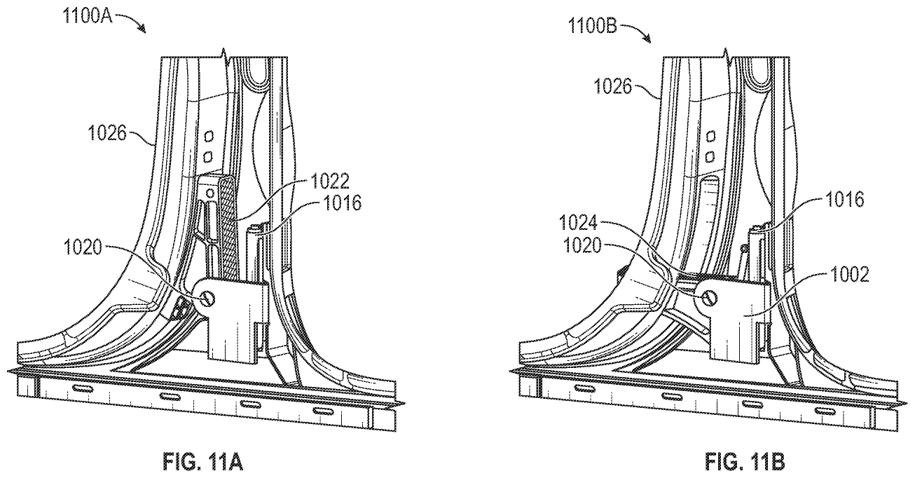

FIG. 11A and FIG. 11B are example diagrams 1100a, 1100b are detailed in views of the structural member in stowed position and deployed position.
1002 Bracket
1004 Motor powered unit assembly
1006 First housing halve
1007 Attachment screws
1008 Second housing halve
1010 Motor
1012 Leadscrew
1014 Nut
1016 Bearing
1018 Linkage
1020 Pivot pins
1022 Structural member
1024 Stepping surface
1026 Sheet metal

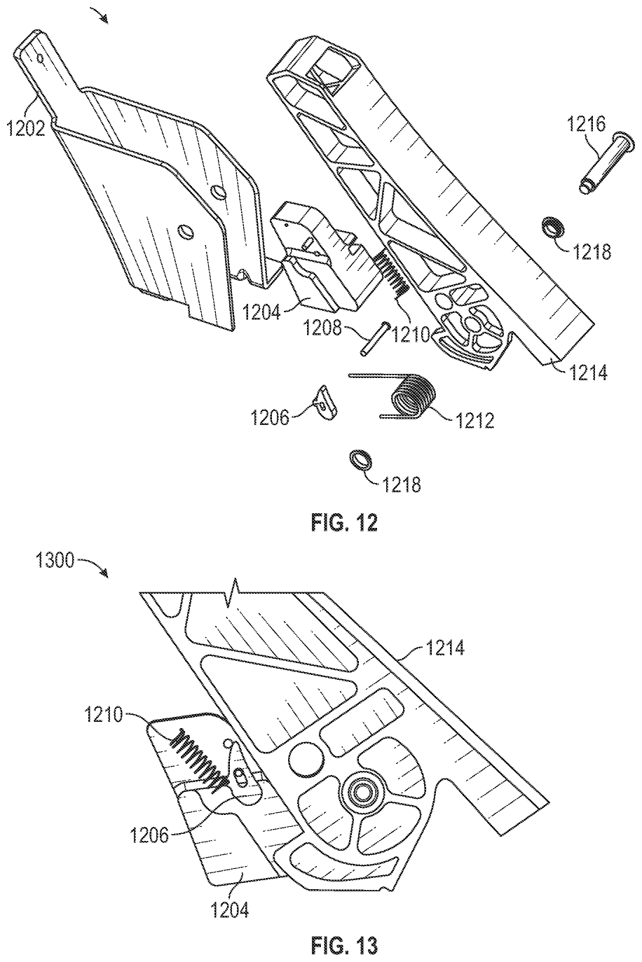

FIG. 12 is an example diagram 1200 is a detailed view of a toggle mechanism for operating the device between deployed positon and stowed position, in accordance with one or more exemplary embodiments.
1202 Bracket
1204 Stop member
1206 Cam mechanism
1208 Pivoting member
1210 Compression spring
1212 Torsion spring
1214 Structural member
1216 Step pin
1218 One or more bushings

FIG. 13 is an example diagram 1300 depicting an embodiment of stowed position of the structural member using toggle mechanism, in accordance with one or more exemplary
1204 Stop member
1206 Cam mechanism
1210 Compression spring
1214 Structural member

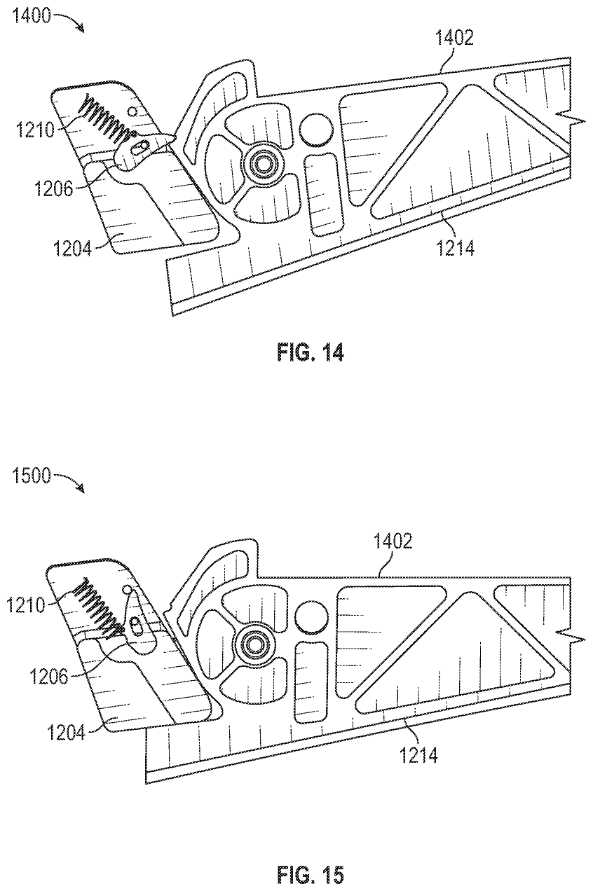

FIG. 14 is an example diagram 1400 depicting an embodiment of transitioning the structural member from the deployed position to the stowed position using a toggle mechanism, in accordance with one or more exemplary embodiments.
1204 Stop member
1206 Cam mechanism
1210 Compression spring
1214 Structural member
1402a Stepping surface of the structural member.

FIG. 15 is an example diagram 1500 depicting an embodiment of transitioning the structural member from the deployed position to the stowed position using a toggle mechanism, in accordance with one or more exemplary embodiments.
1204 Stop member
1206 Cam mechanism
1210 Compression spring
1214 Structural member
1402 Stepping surface of the structural member.

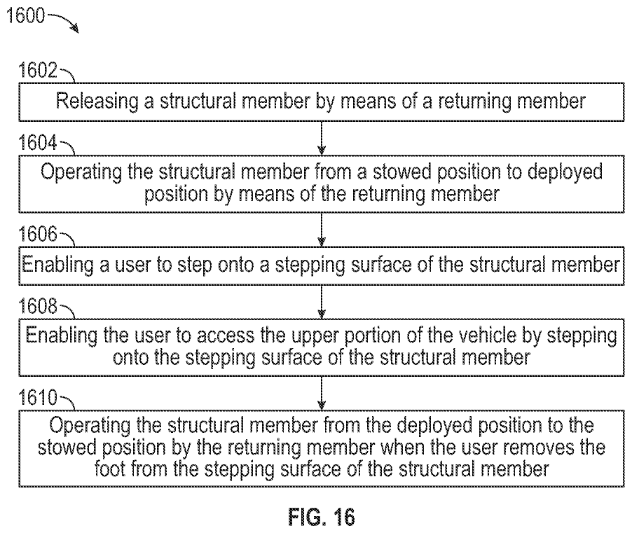

FIG. 16, 1600 discloses a method for accessing the upper portion of the vehicle
Step 1602, Releasing a structural member by means of a returning member
Step 1604, Operating the structural member from a stowed position to deployed position by means of the returning member
Step 1606, Enabling a user to step onto a stepping surface of the structural member
Step 1608, Enabling the user to access the upper portion of the vehicle by stepping onto the stepping surface of the structural member
Step 1610, Operating the structural member from the deployed position to the stowed position by the returning member when the user removes the foot from the stepping surface of the structural member

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

Referring to FIG. 1 is a diagram 100 depicting a device for accessing the upper portion, in accordance with one or more exemplary embodiments. The device 100 includes a structural member 102, a bracket 104, a pin 108, and a returning member 110. The returning member 110 may include but not limited to a spring, and ball and spring mechanism.

The structural member 102 may include stepping surface 112, and a pad. The structural member 102 may be a step or a plate. The structural member 102 may be made from steel metal or other suitable metal. The structural member 102 has a stepping surface 112. The stepping surface 112 of the structural member 102 has a pad. The pad may be placed on the stepping surface 112 of the structural member 102. The pad may include a textured surface or bumps or protrusions to provide grip to the user's foot. The pad may be made of rubber material or other suitable material. The bracket 104 has a proximal portion 106a, a middle portion 106b, and a middle portion 106c.

Referring to FIG. 2 is an exemplary embodiment 200 depicting a device is fixed to the one or more vehicle pillars 202, in accordance with one or more exemplary embodiments. Here upper portion of the vehicle may include but not limited to a roof of the vehicle and an upper side of the vehicle. Diagram 200 includes a vehicle pillar or one or more vehicle pillars 202, the structural member 102, the bracket 104, the returning member 110, and a pin 204. The structural member 102 has a proximal end and a distal end. The distal end of the structural member may be coupled to a proximal portion of the bracket 104 using the returning member 110. One end of the returning member 110 may be attached to the proximal end of the structural member 102, and another end of the returning member 110 may be attached to the proximal portion 106a of the bracket 104. The loaded returning member 110 to close structural member 102 when the structural member 102 is not held open. The returning member 110 may be configured to pull the structural member 102 to its stored or stowed position. This returning member 110 may also provide the safety feature that the vehicle door does not accidentally close on the structural member when the structural member is in the deployed or open position. Therefore, the structural member 102 may need to be pulled by the user's hand or foot to remain in its deployed position. The bracket 104 may include, but not limited to, a bracket and a pin. The bracket 104 has the proximal portion 106a, the middle portion 106b, and the distal portion 106c. The proximal portion 106a, the middle portion 106b, and the distal portion 106c of the bracket 104 may be rigidly attached to the vehicle pillar 202. The middle portion of the securing member 106b has one or more plates 208a, and 208b protruding angularity from the middle portion 106b of the securing member 104. One or more plates may be configured with a plurality of pin holes for enabling an insertion of the plurality of pins 108 for securing the structural member 102 with the vehicle pillar 202.

In one exemplary embodiment, the middle portion of the bracket 106b has a couple of parallel plates 208a, and 208b protruding angularity from the middle portion 106b of bracket 104. A couple of parallel plates 208a, and 208b may be configured with a plurality of pin holes for enabling an insertion of the plurality of pins 108 for securing the structural member 102 with the vehicle pillar 202.

The structural member 102 may be attached to a bracket 104. Further, the bracket 104 may be fastened to vehicle pillar 202. The structural member 102 can be made by the die-casting process or other molding processes.

Referring to FIG. 3 is a diagram 300 depicting an embodiment of the stop member of the device 100, in accordance with one or more exemplary embodiments. The vehicle pillar 202, the bracket 104, the returning member 110, the pin 204, a hole 206, and a stop member 302. The stop member 302 may act as a mechanical stop to control the deployed position of the structural member. The stop member 302 may be attached through the pivot pin 204 and the hole 206. The pivot pin 204 may be a pivot member.

Referring to FIG. 4 is a diagram 400 depicting an embodiment of the deployed position of the structural member, in accordance with one or more exemplary embodiments. The vehicle pillar 202 may include, but not limited to, A-pillar, B-pillar, C-pillar, and D-pillar. The vehicle pillar 202 may provide vertical support to the vehicle. The vehicle pillar 202 with a cavity 402. The cavity 402 may be formed during the manufacturing process of the B-pillar of the vehicle or the C-pillar of the vehicle. In one embodiment, a hatchback vehicle may include an A-pillar, a B-pillar, and a C-pillar. Here the B-pillar of the vehicle may be a midsection of the vehicle, so cavity 402 may be formed on the B-pillar of the vehicle. In another embodiment, an SUV vehicle may include an A-pillar, a B-pillar, a C-pillar, and a D-pillar. Here the B-pillar and the C-pillar of the vehicle may be the midsection of the vehicle. The structural member 102 may be installed on the B-pillar of the vehicle or the C-pillar of the vehicle to access the upper portion of the vehicle. The height and depth of the cavity depend on the device's 100 dimensions.

The cavity 402 may be configured to fit the structural member 102 when in the stowed position. The structural member 102 may be positioned inside a cavity of the vehicle pillar 202.

One end of the returning member 110 may be attached to the proximal end of the structural member 102, and another end of the returning member 110 may be attached to the proximal portion 106a of the bracket 104 (As shown in FIG. 1, FIG. 2, FIG. 3). The returning member 110 may be configured to enable the user to access the upper portion of the vehicle. The loaded returning member 110 in order to close the structural member when the structural member is not held open. The returning member 110 may be configured to pull the structural member to its stowed position. This returning member 110 may also provide the safety feature that the vehicle door does not accidentally close on the structural member 102 when the structural member is in the deployed or open position. Therefore, structural member 102 may need to be pulled by the user's hand or foot to remain in its deployed position. The structural member 102 may be pulled by the user and releasing the stepping surface 112 of the structural member from the bracket 104 in the deployed position. Here manual operation may be pulling the structural member 102. The bracket 104 of the device is positioned in one or more vehicle pillars to accommodate the bracket 104 along with the structural member 102, whereby the stepping surface of the structural member operates between a deployed position and a stowed position using a power source. The power may be supplied from a power source may include but not limited to battery etc.

The bracket 104 (As shown in FIG. 1, FIG. 2, and FIG. 3) may be positioned on the vehicle pillar 202. The vehicle pillar or the one or more vehicle pillars 202 of the vehicle includes the A-pillar of the vehicle, the B-pillar of the vehicle, and the C-pillar of the vehicle. In the deployed position, the stepping surface 112 of the structural member 102 is formed by deploying a longitudinal plane of the structural member horizontally from a flat vertical surface of the vehicle pillar. The returning member 110 may include but not limited to a spring, and a ball and spring mechanism.

In another exemplary embodiment, releasing the stepping surface 112 of the structural member from the bracket, which is positioned on the vehicle pillar 202 by pulling (dragging) the structural member 102 from the bracket.

Referring to FIG. 5 is an example diagram 500 depicting an embodiment of stowed position of the structural member 102, in accordance with one or more exemplary embodiments. The vehicle pillar 202 may include but not limited to, A-pillar, B-pillar, C-pillar, and D-pillar. The vehicle pillar 202 may provide vertical support to the vehicle. The vehicle pillar 202 with a bracket configuration as shown in FIG. 4. In the stowed position, the proximal end of the structural member 102 may be secured through the bracket using the returning member. The returning member 110 may be configured to allow the user to lock the structural member 102 with the bracket of the vehicle pillar 202 when not in use on the stepping surface 112 of the structural member 102. The bracket engages the structural member 102 along its longitudinal direction in the stowed position, thereby enabling the structural member 102 to securely connect with a contour of the vehicle pillar 202.

Referring to FIG. 6 is a diagram 600 depicting a device for accessing the upper portion of the vehicle, in accordance with one or more exemplary embodiments. The device 600 includes a structural member 102, a stepping surface 112, a pad 602, a bracket 604, a ball and spring mechanism 608, and a pin 108. The structural member 102 includes the stepping surface 112, and the pad 602. The structural member 102 may be a step or a plate. The structural member 102 may be made from steel metal or other suitable metal. The bracket 604 has a proximal portion 606a, a middle portion 606b, and a distal portion 606c. The stepping surface 112 of the structural member 102 has a pad 602. The pad 602 may be placed on the stepping surface 112 of the structural member 102. The pad 602 may be made of rubber material or other suitable material. The pad 602 may include a textured surface or bumps or protrusions to provide grip to the user's foot.

Referring to FIG. 7 is an exemplary embodiment 700 depicting a device fixed to the vehicle pillar, in accordance with one or more exemplary embodiments. Diagram 700 includes a vehicle pillar 202, the structural member 102, a bracket 604, a ball spring mechanism 608, and a pin 108. The structural member 102 has a proximal end and a distal end. The distal end of the structural member 102 may be secured with the vehicle pillar 202 by means of bracket 604. The ball and spring mechanism 608 may be configured to secure the proximal end of the structural member 102.

The bracket 604 may include, but not limited to, a bracket, and a pin. The bracket 604 has a proximal portion 606a, a middle portion 606b, and a distal portion 606c. The proximal portion and the distal portion of the bracket 604 may be rigidly attached to the vehicle pillar 202.

The middle portion of the bracket 606b has an attachment member. The attachment member may include one or more parallel plates that may be configured to protrude perpendicular to the middle portion of the bracket 606b. A couple of the parallel plates may be configured with a plurality of pin holes for enabling an insertion of a plurality of pins 108 for securing the structural member 102 with the vehicle pillar 202. The one or more plates may be parallel plates.

The structural member 102 may be attached to a bracket 604. Further, the bracket 604 may be fastened to the vehicle pillar 202. The structural member 102 can be made by the die-casting process or other molding processes.

Referring to FIG. 8 is a diagram 800 depicting an embodiment of the deployed position of the device, in accordance with one or more exemplary embodiments.

The vehicle pillar 202 may include, but not limited to, A-pillar, B-pillar, C-pillar, and D-pillar. The vehicle pillar 202 may provide vertical support to the vehicle. The vehicle pillar 202 with a bracket configuration as shown in FIG. 8. The cavity may be formed during the manufacturing process of the B-pillar of the vehicle or C-pillar of the vehicle. In one embodiment, a hatchback vehicle has an A-pillar, B-pillar, and C-pillar. Here B-pillar of the vehicle may be a midsection of the vehicle, so a cavity may be formed on the B-pillar of the vehicle. In another embodiment, an SUV vehicle has an A-pillar, B-pillar, C-pillar, and D-pillar. The B-pillar and C-pillar of the vehicle may mid section of the vehicle. The structural member 102 may be installed on the B-pillar of the vehicle or the C-pillar of the vehicle to access the upper portion of the vehicle. The height and depth of the cavity 802 depend on the device's 600 dimensions.

The cavity 802 may be configured to fit the structural member 102 when in the stowed position. The cavity 802 may include a ball and spring mechanism 808 configured to enable the user to access the upper portion of the vehicle. The ball and spring 808 may be coupled with each other. The ball and spring mechanism 808 may be activated by manual operation on the ball, thereby compressing the spring and releasing the stepping surface of the structural member from the bracket in the deployed position. Here manual operation may be applying force on the ball. The bracket (604, as shown in FIG. 6) may be positioned on the vehicle pillar 202. Here vehicle pillar 202 may act as a vertical roof support structure for the vehicle. The vehicle pillar 202 of the vehicle includes the B-pillar of the vehicle and the C-pillar of the vehicle. In the deployed position, the stepping surface 112 of the structural member 102 is formed by deploying a longitudinal plane of the structural member horizontally from a flat vertical surface of the vehicle pillar. In another exemplary embodiment, the bracket (604, as shown in FIG. 6) may include a ball and spring mechanism 808 configured to enable the user to access the roof of the vehicle.

In another exemplary embodiment, releasing the stepping surface of the structural member from the bracket (604, as shown in FIG. 6), which is positioned on the vehicle pillar 202 by dragging the structural member 102 from the bracket (604, as shown in FIG. 6).

In another exemplary embodiment, the returning member includes ball and spring mechanism that may be configured to operate the structural member using a power source.

Referring to FIG. 9A and FIG. 9B are example diagrams 900a. 900b are detailed views of the ball and spring mechanism, in accordance with one or more exemplary embodiments. The ball and spring mechanisms 900a and 900b include the ball 902 and a spring 904. The ball 902 may be configured to couple to a spring 904. The ball and spring mechanism 608 may be configured to secure the proximal end of the structural member 102. The user may access the upper portion of the vehicle using a power source or manual operation. The power sources may include but not limited to batteries, etc. The manual operation may include applying force on the ball 902, thereby compressing the spring 904 to release the stepping surface 112 of the structural member 102 in the deployed position. In another exemplary embodiment, the user may access the roof of the vehicle using manual operation.

Referring to FIG. 10A is an example diagram 1000a is a detailed view of power operated device in a stowed position. FIG. 10B is an example diagram 1000b is details view of power operated device in a deployed position. FIGS. 10A and 10B include a bracket 1002, a processing device (not shown), a motor powered unit assembly 1004, and multiple attachment screws 1007. The motor powered unit assembly 1004 includes a first housing halve 1006, the second housing halve 1008. The second housing halve 1008 includes a motor 1010, a lead screw 1012, a nut 114, a bearing 1016, a linkage 1018, and a pivot pin 1020. The processing device (not shown) may be communicated with the motor 1010, a switch (not shown), a structural member 1022, and a stepping surface 1024. The processing device may be configured to enable the user to operate from the deployed position to the stowed position and vice versa through the switch (not shown). when the user pushes the switch. The motor 1010 may include a hall sensor and a ring magnet. The ring magnet may be attached to the rotating part of motor 1010 and the hall sensor may be configured to be mounted nearby the motor 1010, thereby hall sensor may be configured to sense the magnetic field as the ring magnet rotates. The positional feedback/positional information from the hall sensor may be sent to a processing device (not shown), which receives and processes the positional feedback/positional information. Based on the number of hall counts received, the processing device (not shown) can determine the position of the motor 1010. The motor 1010 may be attached to lead screw 1012. The lead screw 1012 and the nut 1014 are held together by a combination friction of their thread. The lead screw 1012 may be a threaded rod that rotates when it is actuated by the motor 1010. The nut 1014 may be configured to translate up and down the lead screw 1012. The linkage 1018 may be configured to attach nut 1014 and the structural member 1022, then stepping surface 1024 of the structural member 1022 may deploy and stowed positions through the linkage 1018 when the motor 1010 is actuated. The linkage 1018 may be attached to the second housing halve 1008 and the structural member 1022 through the pivot pin 1020. The first housing halve 1006 may be attached with a second housing halve 1008 using attachment screws 1007. The motor powered unit assembly 1004 includes the first housing halve 1006 and the second housing halve 1008. The motor powered unit assembly 1004 may be attached to the bracket 1002 through attachment screws 1007. The motor powered unit assembly 1004 may be attached to the vehicle sheet through the attachment screws 1007. The motor powered unit assembly 1004 may be located inside the vehicle. The motor powered unit assembly 1004 may be located along a B-pillar for a front door and a D-pillar for a rear door.

Referring to FIG. 10C is another example diagram 1000c is a detailed view of a power operated device, in accordance with one or more exemplary embodiments. The FIG. 10C includes a bracket (1002, as shown in FIG. 10A, 10B), a processing device (not shown), a motor powered unit assembly 1004, and multiple attachment screws 1007. The motor powered unit 1004 includes a first housing halve 1006, the second housing halve 1008. The second housing halve 1008 includes a motor 1010, a lead screw 1012, a nut 114, a bearing 1016, a linkage 1018, and a pivot pin 1020. The processing device (not shown) may be communicated with the motor 1010, a switch (not shown), a structural member 1022, and a stepping surface 1024. The processing device may be configured to enable the user to operate from the deployed position to the stowed position and vice versa through the switch (not shown), when the user pushes the switch. The motor 1010 may include a hall sensor and a ring magnet. The ring magnet may be attached to the rotating part of the motor 1010 and the hall sensor may be configured to mount nearby the motor 1010, thereby hall sensor may be configured to sense the magnetic field as the ring magnet rotates. The positional feedback/positional information from the hall sensor may be sent to a processing device (not shown), which receives and processes the positional feedback/positional information. Based on the number of hall counts received, the processing device (not shown) can determine the position of the motor 1010. The motor 1010 may be attached to lead screw 1012. The lead screw 1012 and the nut 1014 are held together by the combination of friction of their thread. The lead screw 1012 may be a threaded rod that rotates when it is actuated by the motor 1010. The nut 1014 may be configured to translate up and down the lead screw 1012. The linkage 1018 may be configured to attach nut 1014 and the structural member 1022, then stepping surface 1024 of the structural member 1022 may deploy and stowed positions through the linkage 1018 when the motor 1010 is actuated. The linkage 1018 may be attached to the second housing halve 1008 and the structural member 1022 through the pivot pin 1020. The first housing halve 1006 may be attached with a second housing halve 1008 using attachment screws 1007. The motor powered unit assembly 1004 includes the first housing halve 1006 and the second housing halve 1008. The motor powered unit assembly 1004 may be attached to the bracket 1002 through attachment screws 1007. The motor powered unit 1004 assembly may be attached to the vehicle sheet through the attachment screws 1007. The motor powered unit assembly 1004 may be located inside the vehicle. The motor powered unit assembly 1004 may be located along B-pillar for a front door and D-pillar for a rear door.

Referring to FIG. 11A and FIG. 11B are example diagrams 1100a, 1100b are detailed in views of the structural member stowed position and deployed position. The vehicle pillar may include but not limited to, A-pillar, B-pillar, C-pillar, and D-pillar. The vehicle pillar may provide vertical support to the vehicle. The vehicle pillar with a cavity. The cavity may be formed during the manufacturing process of the B-pillar of the vehicle or the D-pillar of the vehicle. Structural members may be located along the B-pillar for the front door of the vehicle and the D-pillar for the rear door of the vehicle. The motor powered unit assembly 1004 may be located inside the vehicle. The motor powered unit assembly 1004 may be located along B-pillar for the front door and D-pillar for the rear door. In the stowed position, the proximal end of the structural member may be secured through the bracket 1002. The motor powered unit assembly 1004 may be configured to allow the user to lock the structural member 1022 of the vehicle pillar when not in use on the stepping surface 1024 of the structural member 1022. The bracket 1002 engages the structural member 1022 to securely align with a contour of the vehicle pillar.

Referring to FIG. 11B are example diagrams 1100b are detailed views of a deployed position of the structure, in accordance with one or more exemplary embodiments. The vehicle pillar may include, but not limited to, A-pillar, B-pillar, C-pillar, and D-pillar. The vehicle pillar may provide vertical support to the vehicle. The vehicle pillar with a bracket 1002. The cavity may be formed during the manufacturing process of the B-pillar of the vehicle or the C-pillar of the vehicle. In one embodiment, a hatchback vehicle may include an A-pillar, a B-pillar, and a C-pillar. Here the B-pillar of the vehicle may be a midsection of the vehicle, so cavity may be formed on the B-pillar of the vehicle. The structural member 1022 may be attached with sheet metal 1026, in accordance with one or more exemplary embodiments. In another embodiment, an SUV vehicle may include an A-pillar, a B-pillar, a C-pillar, and a D-pillar. Here the B-pillar and the C-pillar of the vehicle may be the midsection of the vehicle. The structural member 1022 and the motor powered unit assembly 1004 may be installed on the B-pillar of the vehicle or the C-pillar of the vehicle to access the upper portion of the vehicle. The height and depth of the cavity depend on the device's dimensions. The embodiment includes a bracket 1002, a processing device (not shown), a motor powered unit assembly 1004, and multiple attachment screws. The motor powered unit assembly 1004 includes a first housing halve 1006, the second housing halve 1008, the motor 1010, the lead screw 112, bearing 1016, linkage 1012, nut 1014, stepping surface 1024 of the structural member 1022, and the pivot pin. The processing device (not shown) may be communicated with the motor 1010, a switch (not shown), and stepping surface 1024 of the structural member 1022. In deployable structural member operation, the processing device may be configured to enable the user to deploy the structural member when the user presses the switch. The motor 1010 may include a hall sensor and a ring magnet. The ring magnet may be attached to the rotating part of the motor and the hall sensor may be configured to mount nearby the motor, thereby hall sensor may be configured to sense the magnetic field as the ring magnet rotates. The positional feedback from the hall sensor may be sent to a processing device, which receives and processes the information. Based on the number of hall counts received, the processing device can determine the position of the motor. Then the structural member may be deployed from the bracket 1002 of the vehicle based on the processing device giving instructions to the motor after the user pushes the switch.

Referring to FIG. 12 an example diagram 1200 is a detailed view of a toggle mechanism for operating the device between a deployed position and stowed position, in accordance with one or more exemplary embodiments. The toggle mechanism 1200 includes a bracket 1202, a stop member 1204, a cam mechanism 1206, a pivoting member 1208, a compression spring 1210, a torsion spring 1212, a structural member 1214, a step pin 1216 and one or more bushings 1218. The toggle mechanism that may be implemented within the device 1200 offers an elevated level of efficiency and precise control over stepping motion.

The bracket may include but not limited to a mounting bracket. The bracket 1202 may be configured to provide stability and support for the structural member. The stop member 1204 may be located inside of the mounting bracket 1202. The stop member 1204 may be configured to limit the movement of the toggle mechanism within a predefined range. The stop member 1204 may prevent excessive motion and ensures controlled a stepping surface of the structural member. The stop member may be configured to attach the cam mechanism 1206 by pivoting member 1208. The structural member 1214 includes a proximal end and a distal end. The distal end of the structural member 1214 may be secured within the bracket 1214 using a step pin 1216 and one or more bushings 1218. The one or more bushings 1218 may be positioned within the bracket to facilitate smooth rotation of the structural member 1214.

The torsion spring 1212 may include a first end and a second end. The first end of the torsion spring 1212 may be attached to the structural member 1214 and the second end of the torsion spring may be attached to the bracket 1214. The torsion spring may be configured to rotate the structural member from a stowed position to a deployed position upon applying force on a stepping surface of the structural member by the user. The compression spring 1210 may be positioned within the bracket 1202. The cam mechanism 1206 may be configured to flexibly connect to the bracket using a pivoting member 1208. The cam mechanism 1206 may be configured to engage with the compression spring 1210 to control the motion of the structural member from the deployed position to the stowed position when the user removes the weight or force applied from the stepping surface of the structural member. The torsion spring 1212 and the compression spring 1210 may be configured to enable the structural member to move between the deployed position and the stowed position. The first end of the torsion spring 1212 may be attached to the structural member 1214 and the second end of the torsion spring 1212 may be attached to the stop member 1204 of the bracket 1202.

Referring to FIG. 13 is an example diagram 1300 depicting an embodiment of stowed position of the structural member 1214 using a toggle mechanism, in accordance with one or more exemplary embodiments. The diagram 1300 includes the stop member 1204, the cam mechanism 1206, the compression spring 1210, and the structural member 1214.

Referring to FIG. 14 is an example diagram 1400 depicting an embodiment of transitioning the structural member from the deployed position to the stowed position using a toggle mechanism, in accordance with one or more exemplary embodiments. The diagram 1400 includes the stop member 1204, the cam mechanism 1206, the compression spring 1210, and the structural member 1214, a stepping surface 1402 of the structural member.

The distal end of the structural member 1214 (as shown in FIG. 12) may be secured within a bracket 1202 using the step pin 1216 and one or more bushings 1218 (as shown in FIG. 12). The user may apply force on the stepping surface of the structural member 1214, thereby the torsion spring 1212 may be configured to rotate the structural member 1402 from the stowed position to the deployed position.

Referring to FIG. 15 is an example diagram 1500 depicting an embodiment of changing from the deployed position to stowed position of the structural member 1214 using a toggle mechanism, in accordance with one or more exemplary embodiments. The compression spring 1210 may be positioned within the bracket and the cam mechanism flexibly connected to the bracket 1202 using pivoting member 1208 (as shown in FIG. 12). The user removes the force applied or weight from the stepping surface of the structural member thereby the cam mechanism 1206 configured to engage with the compression spring 1210 to control the motion of the structural member 1214 from the deployed position to the stowed position. The torsion spring 1212 and the compression spring 1210 may be configured to enable the structural member 1214 to move between the deployed position and the stowed position.

Referring to FIG. 16 is a flow diagram 1600 depicting a method for accessing the upper portion of the vehicle. The method 1600 may be carried out in the context of the details of FIG. 1, FIG. 2, FIG. 3, FIG. 4, FIG. 5, FIG. 6, FIG. 7, FIG. 8, FIG. 9, FIG. 10A, FIG. 10B, FIG. 10C, FIG. 11A, FIG. 11B, FIG. 12, FIG. 13, FIG. 14, and FIG. 15. However, the method 1600 may also be carried out in any desired manner. Further, the aforementioned definitions of the device may equally apply to the description below.

The method commences at step 1602, by releasing a structural member by means of a returning member. Thereafter at step 1604, operating the structural member from a stowed position to deployed position by means of the returning member. Thereafter at step 1606, enabling a user to step onto a stepping surface of the structural member. Thereafter at step 1608, enabling the user to access the upper portion of the vehicle by stepping onto the stepping surface of the structural member. Thereafter at step 1610, operating the structural member from the deployed position to the stowed position by the returning member when the user removes the foot from the stepping surface of the structural member.

According to the non-limiting exemplary embodiment, the proposed invention provides a versatile solution that caters to a diverse set of needs and industries. This inclusive approach ensures that the proposed invention is adaptable and applicable across a wide array of moving items, including but not limited to heavy vehicles, light motor vehicles, off-road vehicles, boats, campers, 4-wheelers, and various other types of vehicles used in both onshore and offshore environments. Furthermore, it can be applied to specialized vehicles such as offshore vehicles, hovercrafts, and any other form of transportation that involves movement on land, water, or both.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A device for enabling a user to access an upper portion of a vehicle comprising:
a structural member comprising:
a proximal end and a distal end, whereby the distal end of the structural member secured within a bracket by means of a returning member;
a stepping surface of the structural member configured to flexibly move within the bracket by means of the returning member, whereby the structural member operates between a deployed position and a stowed position thereby enabling the user to access the upper portion of the vehicle; and
the bracket of the device positioned in one or more vehicle pillars to accommodate the structural member, whereby the stepping surface of the structural member operates between the deployed position and the stowed position by means of a motor-powered unit assembly, wherein the stepping surface of the structural member angularly positioned when the structural member operates in the deployed position thereby enabling the user to access the upper portion of the vehicle.

2. The device of claim 1, wherein the returning member comprises at least one of: a spring;
and a ball and spring mechanism.

3. The device of claim 1, wherein the bracket comprises a proximal portion, a distal portion, and a middle portion.

4. The device of claim 3, wherein the proximal portion, the middle portion, and the distal portion of the bracket are rigidly attached to the one or more vehicle pillars.

5. The device of claim 1, wherein the bracket is configured to engage the structural member along its longitudinal direction in the stowed position and enable the structural member to securely align to a contour of the one or more vehicle pillars.

6. The device of claim 1, wherein the structural member is configured to operate flexibly from at least one of: the deployed position to the stowed position; and the stowed position to the deployed position by means of manual operation.

7. The device of claim 1, wherein the structural member is configured to release from the bracket positioned inside of the one or more vehicle pillars upon pulling the structural member by the user.

8. The device of claim 1, wherein the stepping surface comprises a pad with a textured surface configured to provide a grip to the user's foot.

9. The device of claim 1, wherein the one or more vehicle pillars comprise A-pillar, B-pillar, C-pillar, and D-pillar.

10. The device of claim 1, further comprises a stop member that acts as a mechanical stop to control the deployed position of the structural member.

11. The device of claim 10, wherein the stop member is attached through a pivoting member and a hole in a rear portion of the bracket.

12. The device of claim 1, wherein the upper portion of the vehicle comprises a roof of the vehicle.

13. The device of claim 1, wherein the structural member is secured within the bracket, and is configured to flexibly move within the bracket by means of the returning member, whereby the structural member operates between the deployed position and the stowed position and enables the user to access the upper portion of the vehicle, the structural member further configured to operate from the deployed position to the stowed position by the returning member when the user removes the foot from the stepping surface of the structural member.

14. The device of claim 1, wherein the motor-powered unit assembly comprising:
a switch, a processing device, and a motor, whereby the switch configured to enable the user to activate the motor, the motor comprises a ring magnet, and a hall sensor configured to send the positional feedback to the processing device thereby controlling the motor to operate the structural member between the deployed position and the stowed position; and
the processing device configured to enable the motor to release the stepping surface of the structural member from the bracket in the deployed position, and the processing device further configured to secure the stepping surface of the structural member inside the bracket in the stowed position.

15. The device of claim 14, wherein the motor is connected to the structural member by means of a lead screw, and a linkage.

16. The device of claim 1, wherein the vehicle comprises heavy vehicles, light motor vehicles, off-road vehicles, boats, campers, 4-wheelers, hovercrafts and various other types of vehicles used in both onshore and offshore environments for transporting items across a wide array of industries.

17. A device for enabling a user to access an upper portion of a vehicle comprising:
a structural member comprising:
a proximal end and a distal end, whereby the distal end of the structural member secured within a bracket by means of a step pin and one or more bushings;
a torsion spring comprises a first end and a second end, wherein the first end of the torsion spring attached to the structural member and the second end of the torsion spring attached to the bracket, whereby the torsion spring configured to rotate the structural member from a stowed position to a deployed position upon applying force on a stepping surface of the structural member by the user; and
a compression spring positioned within the bracket and a cam mechanism flexibly connected to the bracket by means of a cam pin, whereby the cam mechanism configured to engage with the compression spring to control the motion of the structural member from the deployed position to the stowed position when the user removes force applied from the stepping surface of the structural member, the torsion spring and the compression spring configured to enable the structural member to move between the deployed position and the stowed position.

18. The device of claim 17, wherein the bracket comprises a stop member configured to attach the cam mechanism by means of the pivoting member.

19. The device of claim 17, wherein the first end of the torsion spring attached to the structural member and the second end of the torsion spring attached to the stop member of the bracket.

20. The device of claim 17, wherein the one or more bushings positioned within the bracket to facilitate smooth rotation of the structural member.
